(19) United States
(12) Patent Application Publication
(10) Pub. No.: US 2026/0307623 A1
(43) Pub. Date: Oct. 8, 2026

(54) VEHICLE COMPONENT WASHER SYSTEM WITH RECIRCULATION

(71) Applicant: A. RAYMOND ET CIE, Grenoble (FR)

(72) Inventor: Larry M. Rachow, Lenox, MI (US)

(21) Appl. No.: 19/482,387

(22) PCT Filed: May 15, 2024
(86) PCT No.: PCT/IB2024/054736

§ 371 Date: Nov. 7, 2025

Related U.S. Application Data
(60) Provisional application No. 63/467,461, filed on May 18, 2023.

(51) Int. Cl. B60S 1/48; B60S 1/50; B60S 1/52; B60S 1/58; B60S 1/60

(52) U.S. Cl. CPC B60S 1/481; B60S 1/488; B60S 1/50; B60S 1/52; B60S 1/58; B60S 1/603

(57) ABSTRACT

A system for washing exterior surfaces of vehicle components includes a reservoir tank having a fluid recirculation inlet and a fluid recirculation outlet. A recirculation pump is in fluid communication with the fluid recirculation outlet of the reservoir tank. A recirculation conduit has a first end in fluid communication with the recirculation pump and a second end in fluid communication with the fluid recirculation inlet of the reservoir tank. The recirculation pump is configured to be actuated to circulate fluid to and from the reservoir tank through the recirculation conduit. At least one cleaning pump is in fluid communication with the reservoir tank and the recirculation conduit, and is configured to be actuated to eject fluid from one or more nozzle assemblies. The recirculation pump is actuated only for recirculation of fluid through the recirculation conduit, and the cleaning pump is actuated only to eject fluid from the nozzle assemblies.

### CROSS REFERENCE TO RELATED APPLICATIONS

This application claims the benefit of U.S. Application No. 63/467,461, filed May 18, 2023, the disclosure of which is incorporated by reference in its entirety.

### FIELD OF THE INVENTION

The disclosure generally relates to systems and methods for washing external vehicle components and, more specifically, to a vehicle washer system and method having fluid recirculation.

### BACKGROUND OF THE INVENTION

External view cameras (e.g., front bumper, side-view, rear-view, or backup cameras) as well as external sensors are becoming more commonplace in automotive vehicles to enhance a driver's vision, to improve safety, and to allow for autonomous control of a vehicle. External cameras allow drivers to see obstacles or other objects are in the vicinity of the vehicle, and external sensors provide roadway feedback that may be used to provide a visual or audio cue to the driver or that may be used by an onboard computer to control the driving of the vehicle. However, these external cameras and sensors are exposed to the environment surrounding the vehicle, and often become soiled by dirt, mud, salt spray or other debris which accumulates on the camera lens or sensor, thereby disturbing the normal functioning of these devices.

To combat the accumulation of dirt and debris on camera lenses and sensors, spray nozzles may be provided near the camera lens or sensor. The spray nozzle may eject washer fluid or another similar cleaning fluid on the lens or sensor to remove the built-up debris. Spray nozzles may also be used to clean other external surfaces on a vehicle such as headlamps, tail lamps, side markers, and turn signals. Additionally, spray nozzles are used to wash the glass of vehicle front windshields and rear windows. The spray nozzles may all be connected to a vehicle's washer fluid reservoir, and may eject washer fluid delivered from the reservoir. However, in cold weather conditions, the washer fluid may become frozen in the fluid supply lines connecting the reservoir to the spray nozzles. Heating elements may be provided along the supply lines to warm the washer fluid and protect against freezing. However, heating elements add to the cost and complexity of the washer system.

### BRIEF SUMMARY

An improved vehicle component washer system for washing exterior surfaces of vehicle components is provided. The vehicle component washer system recirculates the washer fluid to defend against freeze up in the supply lines, and reduces, limits, or eliminates the use of heating elements along the supply lines. The washer system also allows for the use of lower or no antifreeze washer solutions in cold weather, as well as alternative washer solutions. The washer system includes a reservoir tank having a fluid recirculation inlet and a fluid recirculation outlet. A recirculation pump is in fluid communication with the fluid recirculation outlet of the reservoir tank. A recirculation conduit has a first end in fluid communication with the recirculation pump and a second end in fluid communication with the fluid recirculation inlet of the reservoir tank. The recirculation pump and the recirculation conduit form a closed loop between the reservoir tank outlet and reservoir tank inlet. The recirculation pump is configured to be actuated to circulate fluid to and from the reservoir tank through the recirculation conduit. A plurality of nozzle assemblies are connected to the recirculation conduit at various positions along the recirculation conduit. The nozzle assemblies each include a nozzle valve and spray nozzle. The nozzle valve is configured to be actuated to communicate fluid from the recirculation conduit to the spray nozzle. A recirculation control valve is in fluid communication with the recirculation conduit. The recirculation control valve is connected to the recirculation conduit at a location downstream from the plurality of nozzle assemblies and upstream from the reservoir tank inlet. At least one cleaning pump is in fluid communication with the reservoir tank and the recirculation conduit. The at least one cleaning pump is connected to the recirculation conduit at a location upstream from the plurality of nozzle assemblies, and the at least one cleaning pump is configured to be actuated to eject fluid from the nozzle assemblies to perform the cleaning function. The recirculation pump is actuated only for recirculation of fluid through the recirculation conduit, and the cleaning pump is actuated only to eject fluid from the nozzle assemblies to perform the cleaning function.

In specific embodiments, the at least one cleaning pump is additionally connected to the recirculation conduit at a location upstream from nozzle assemblies dedicated for the vehicle front windshield.

In particular embodiments, the system includes only one cleaning pump. The only one cleaning pump has a first outlet connected to the location upstream of the plurality of nozzle assemblies, and a second outlet connected to the location upstream of the nozzle assemblies dedicated for the vehicle front windshield.

In specific embodiments, the system includes an auxiliary conduit in fluid communication with the at least one cleaning pump and a plurality of nozzles associated with a vehicle front windshield.

In specific embodiments, the system includes a check valve connected to the recirculation conduit between the recirculation pump and the location at which the at least one cleaning pump is connected to the recirculation conduit upstream from the plurality of nozzle assemblies.

In specific embodiments, the system includes a check valve connected between the at least one cleaning pump and the location at which the at least one cleaning pump is connected to the recirculation conduit upstream from the plurality of nozzle assemblies.

In particular embodiments, the system includes a check valve connected between the at least one cleaning pump and the location at which the at least one cleaning pump is connected to the recirculation conduit upstream from the nozzle assemblies associated with the vehicle front windshield.

In specific embodiments, the plurality of nozzle assemblies are associated with one or more of external sensors, external camera lenses, headlamps, tail lamps, side markers, turn signals, a front windshield, and a rear window.

In specific embodiments, the recirculation control valve and the valve of each valve assembly are electronically controlled valves.

In specific embodiments, the system includes a controller configured to operate the recirculation pump, the at least one cleaning pump, the recirculation control valve, and the valves of the plurality of nozzle assemblies.

A method of washing exterior surfaces of external vehicle components is also provided. The method includes opening the recirculation control valve and actuating the recirculation pump to circulate washer fluid to and from the reservoir tank through the recirculation conduit during non-use of the nozzle assemblies. The method also includes deactivating the recirculation pump during use of the nozzle assemblies, closing the recirculation control valve, actuating the at least one cleaning pump, and opening one or more of the nozzle valves of the plurality of nozzle assemblies to eject fluid from the associated spray nozzles. Fluid is thereby recirculated only during non-use of the nozzle assemblies.

In specific embodiments, the at least one cleaning pump is actuated to deliver fluid from the reservoir tank to the location upstream of the plurality of nozzle assemblies.

In specific embodiments, the at least one cleaning pump is actuated to deliver washer fluid from the reservoir tank to a location upstream of nozzle assemblies associated with a vehicle front windshield.

In specific embodiments, the method includes providing a controller configured to operate the recirculation pump, the at least one cleaning pump, the recirculation control valve, and the valves of the plurality of valve assemblies.

In specific embodiments, the method includes measuring the temperature of the fluid in the recirculation conduit.

In particular embodiments, the method includes controlling the recirculation pump based on the measured temperature.

In particular embodiments, the method includes controlling the temperature of the fluid based on the measured temperature.

In specific embodiments, the method includes transferring heat from one or more of the vehicle components to the washer fluid in the recirculation conduit.

### DESCRIPTION OF THE DRAWINGS

Various advantages and aspects of this disclosure may be understood in view of the following detailed description when considered in connection with the accompanying drawings, wherein:

FIG. 1 shows a schematic view of a washer system in a recirculation mode including operation of front windshield nozzles in accordance with some embodiments of the disclosure;

FIG. 2 shows a schematic view of a washer system in a recirculation mode not including operation of the front windshield nozzles in accordance with other embodiments of the disclosure;

FIG. 3 shows another schematic view of the washer system bill of material in accordance with other embodiments of the disclosure;

FIG. 4 shows another schematic view of the washer system in a recirculation mode not including operation of the front windshield nozzles in accordance with other embodiments of the disclosure;

FIG. 5 shows a schematic view of the washer system in the front windshield nozzle activation mode including operation of the front windshield nozzles in accordance with some embodiments of the disclosure;

FIG. 6 shows a schematic view of the washer system in the front windshield nozzle activation mode including operation of the front windshield nozzles in accordance with other embodiments of the disclosure;

FIG. 7 shows another schematic view of the washer system in the front windshield nozzle activation mode including operation of the front windshield nozzles in accordance with other embodiments of the disclosure;

FIG. 8 shows a schematic view of the washer system in the rear glass nozzle activation mode not including operation of the front windshield nozzles in accordance with some embodiments of the disclosure;

FIG. 9 shows a schematic view of the washer system in the rear glass nozzle activation mode not including operation of the front windshield nozzles in accordance with other embodiments of the disclosure;

FIG. 10 shows another schematic view of the washer system in the component cleaning activation mode not including operation of the front windshield nozzles in accordance with other embodiments of the disclosure;

FIG. 11 shows a schematic view of the washer system in the component cleaning activation mode including operation of the front windshield nozzles in accordance with some embodiments of the disclosure;

FIG. 12 shows a schematic view of the washer system in the component cleaning activation mode not including operation of the front windshield nozzles in accordance with other embodiments of the disclosure; and

FIG. 13 shows a schematic view of the washer system in accordance with other embodiments of the disclosure including heat transfer in the recirculation mode.

### DETAILED DESCRIPTION OF THE INVENTION

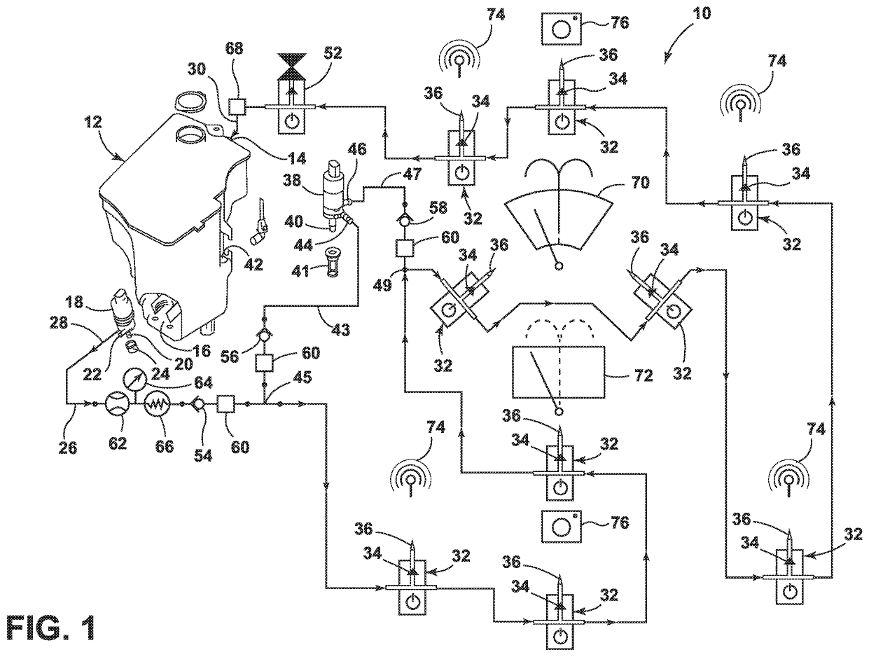

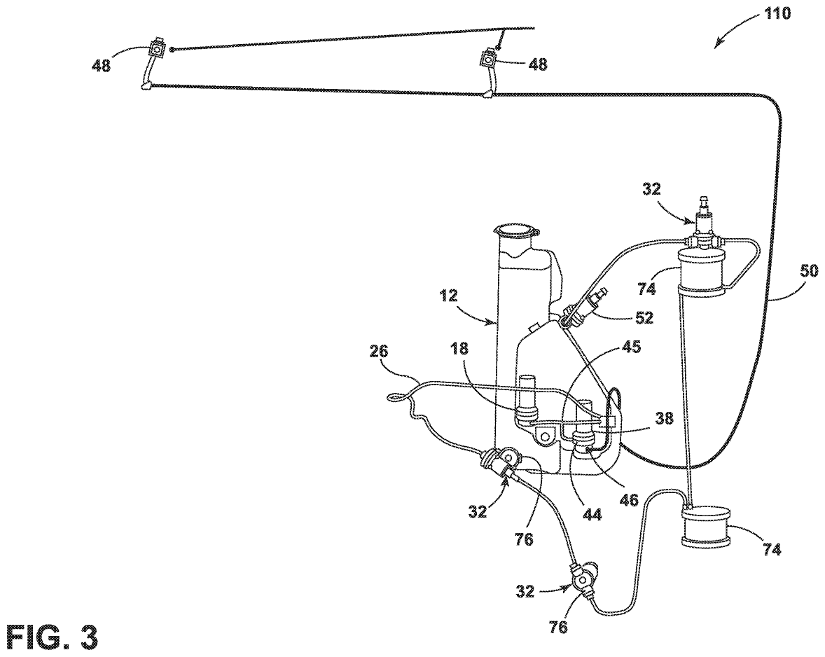

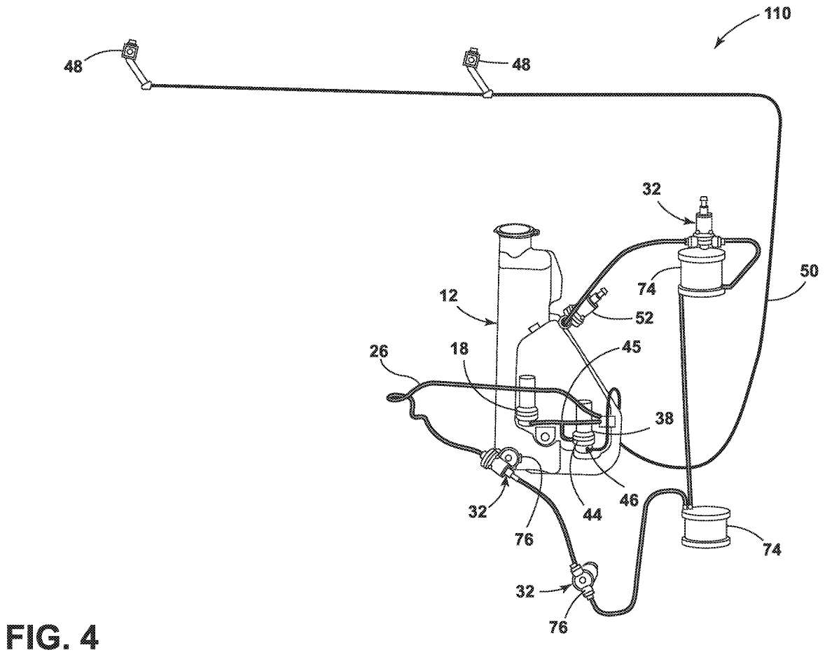

A system for washing exterior surfaces of vehicle components is provided. Referring to FIGS. 1-13, wherein like numerals indicate corresponding parts throughout the several views, the washer system is illustrated and generally designated at 10, 110. Certain features of the washer system 10, 110 are functional, but can be implemented in different aesthetic configurations.

Turning first to FIG. 1, the washer system 10 includes a reservoir tank 12 having a fluid recirculation inlet 14 and a fluid recirculation outlet 16. The reservoir tank 12 may have any of the features of a conventional vehicle washer fluid reservoir tank (i.e., washer bottle), such as but not limited to a fill opening and/or spout, filters, a fill cap that covers, closes, and seals the fill opening, and a fluid level sensor that provides an indication when the level/amount of washer fluid in the reservoir is low. The reservoir tank may have a typical capacity of one gallon minimum, alternatively in the range of approximately 0.5 to 1.5 gallons, but is not limited to a particular volume. The reservoir tank 12 may be located in the engine compartment of the vehicle, but is not limited to this location and may be disposed in other areas of the vehicle.

A dedicated recirculation pump 18 is connected to and in fluid communication with the fluid recirculation outlet 16 of the reservoir 12. Unless otherwise specified, as used herein the term “connected to” in relation to the components of the fluid system means that the components have a fluid connection such that fluid can flow between and be communicated from one component to the other. The recirculation pump 18 has an inlet 20 and outlet 22. A particle filter 24 may be disposed at or between the connection of the pump inlet 20 and the reservoir outlet 16, in order to prevent debris from exiting the reservoir into the recirculation pump. The recirculation pump may be a low voltage, low capacity/pressure pump and may provide a liquid flow rate in the range of, for example, 450 to 950 mL per minute.

A recirculation conduit 26 is connected to and in fluid communication with the outlet 22 of the recirculation pump 18. The recirculation conduit 26 has a first end 28 and an opposite second end 30. The first end 28 is connected to the recirculation pump 18 and the second end 30 is connected to and in fluid communication with the fluid recirculation inlet 14 of the reservoir tank 12. The recirculation pump 18 and the recirculation conduit 26 thereby form a closed loop between the reservoir tank outlet 16 and reservoir tank inlet 14 such that washer fluid exiting the reservoir 12 via outlet 16 travels through the recirculation conduit 26 and may return to the reservoir tank via inlet 14. Hence, the first end 28 of the recirculation conduit is an upstream end, and the second end 30 is a downstream end, with the direction of flow moving upstream to downstream from the first end to the second end. The recirculation pump 18 is configured to be actuated to circulate fluid to and from the reservoir tank 12 through and along the flow path provided by the recirculation conduit 26. As described in more detail below, the recirculation pump 18 is referred to as a “dedicated” recirculation pump because pump 18 is used solely to recirculate the washer fluid internally within the system, and not for ejection of washer fluid from the system. As such, the recirculation pump 18 is not required to provide a fluid output pressure sufficient for fluid cleaning (e.g., sufficient to eject fluid from nozzles in a manner that the fluid can spray on a surface so as to clean the surface), and only need to provide a fluid output pressure sufficient for the fluid to flow through the recirculation conduit 26 back to the reservoir 12. Hence, the recirculation pump 18 may or may not have the have the same or similar output specifications as a pump used for fluid cleaning.

A plurality of nozzle assemblies 32 are connected to and in fluid communication with the recirculation conduit 26 at various positions along the recirculation conduit. Each nozzle assembly 32 is associated with a vehicle component to provide for the washing/cleaning of that vehicle component. For example, one of the nozzle assemblies may be disposed in proximity to an external sensor, another nozzle assembly may be disposed in proximity to an external camera lens, and another nozzle assembly may be disposed in proximity to a front windshield or rear window. Thus, the recirculation conduit 26 may travel throughout the vehicle from front to back and back to front in order to provide washer fluid flow to the nozzle assemblies disposed at various locations around the vehicle. Each nozzle assembly 32 includes a nozzle valve 34 and spray nozzle 36. The nozzle valve 34 is configured to be actuated to communicate fluid from the recirculation conduit 26 to the spray nozzle 36. Actuation (i.e., opening) of the nozzle valve 34 allows fluid to pass from the recirculation conduit to the spray nozzle 36 where it is ejected from the nozzle onto the specific exterior vehicle component in proximity to the nozzle as described in more detail below. Particularly, the nozzle valve 34 may be an electronic valve that is electronically actuated by a controller (see below). The spray nozzle 36 is not particularly limited and may be any of a variety of spray nozzles known in the art for use in a vehicle. Also, different types of spray nozzles may be used in the system, depending on the vehicle component that the spray nozzle is associated with, i.e. oscillating fan spray nozzles used for the windshield and static fan spray nozzles for rear glass may or may not be different than the spray nozzles used for the camera lenses which may or may not be different than spray nozzles used for the sensors, as so on.

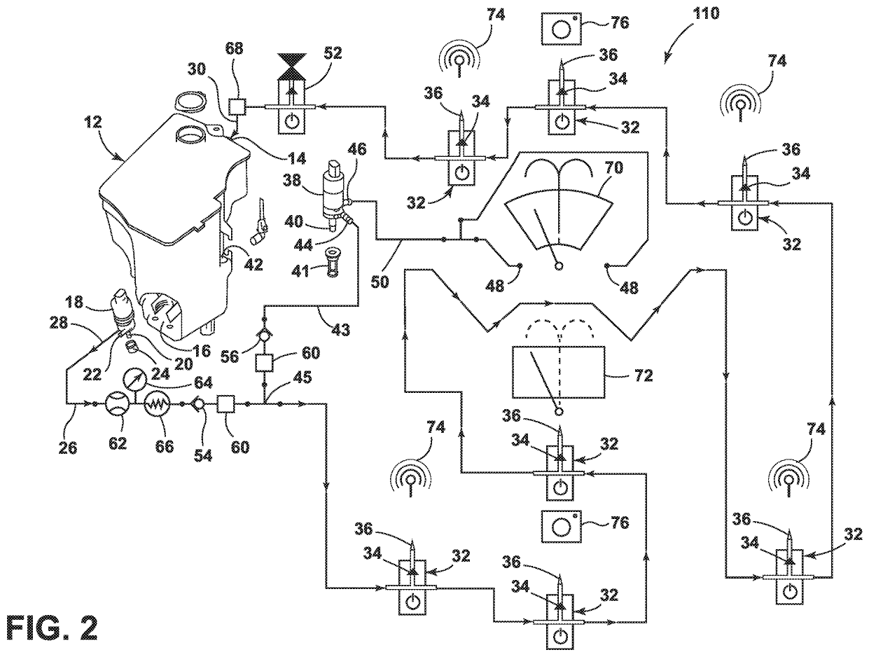

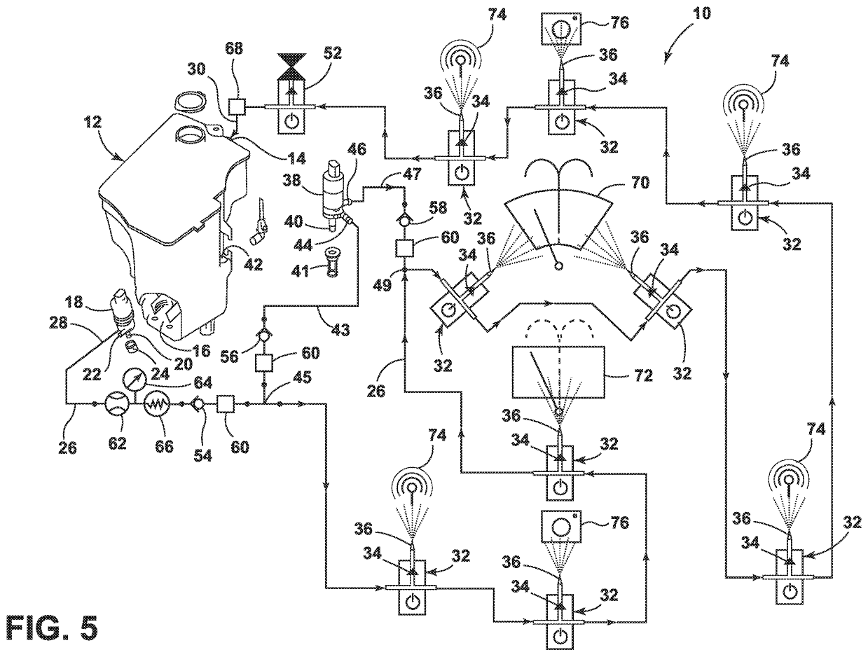

At least one cleaning pump 38 is connected to and in fluid communication with both the reservoir tank 12 and the recirculation conduit 26. In some embodiments, the system includes only one cleaning pump that is a dual output pump. In these embodiments, the cleaning pump 38 has an inlet 40 that is connected to a second outlet 42 of the tank 12, a first outlet 44 that is connected to the recirculation conduit 26 by a first supply conduit 43 at a location 45 upstream from the plurality of nozzle assemblies 32 (the connection may be, for example, a T-connector), and a second outlet 46 that is connected to the specific nozzle assemblies associated with the vehicle front windshield. A particle filter 41 may be disposed at or between the connection of the pump inlet 40 and the tank second outlet 42, in order to prevent debris from exiting the reservoir into the cleaning pump. In the specific embodiments of the system 10 shown in FIGS. 1, 5 8, and 11, the second outlet 46 is connected to the recirculation conduit 26 by second supply conduit 47 at a location 49 just upstream from the specific nozzle assemblies associated with the vehicle front windshield (and downstream from the nozzles that are upstream from the nozzles associated with the front windshield). These embodiments are referred to as a recirculating front arrangement. In the specific embodiments of the system 110 shown in FIGS. 2-4, 6, 7, 9, 10, and 12, the nozzles 48 for the front windshield are instead separate from the recirculation conduit 26 and are connected to the second outlet 46 of the cleaning pump 38 via an auxiliary conduit 50. These embodiments are referred to as a traditional front washing arrangement. In yet other alternative embodiments, the system may include two cleaning pumps (not shown) for additional flexibility, with one of these two pumps including the outlet connected upstream of the plurality of nozzle assemblies and the other pump including the outlet connected upstream of the nozzles associated with the vehicle front windshield.

The cleaning pump 38 is a washer fluid pump that is capable of delivering a fluid pressure sufficient to eject liquid (e.g., washer fluid) spray from the nozzles of the nozzle assemblies so as to clean a surface onto which the washer fluid is sprayed. The cleaning pump may be a high voltage, high capacity/pressure pump and thereby may provide a fluid output pressure approximately in the range of 35 to 130 psi. The cleaning pump 38 is configured to be actuated to eject fluid from the nozzle assemblies. Specifically, the cleaning pump 38 is actuated only to eject fluid from the nozzle assemblies 32, while the recirculation pump 18 is actuated only for recirculation of fluid through the recirculation conduit 26.

A recirculation control valve 52 is connected to and in fluid communication with the recirculation conduit 26 at a location downstream from all the plurality of nozzle assemblies 32 and upstream from the reservoir tank recirculation inlet 14. The recirculation control valve 52 is activated to an open position to allow washer fluid to be circulated to and from the reservoir tank 12 through the recirculation conduit 26 when the recirculation pump 18 is operating. Oppositely, when the recirculation pump 18 is turned off, the recirculation control valve 52 is moved to a closed position to prevent fluid from flowing downstream into the reservoir tank recirculation inlet 14 and to allow the system to pressurize during the activation of the cleaning pump 38. When the recirculation control valve 52 is closed, the cleaning pump 38 may be actuated to pump fluid from the reservoir tank 12 for ejection from the nozzles 36 of the nozzle assemblies 32 by selectively opening and closing the nozzle assembly valves 34.

The system may further include one or more check valves to prevent backflow of fluid in the conduits. As shown by example in FIG. 1, a check valve 54 is connected to the recirculation conduit 26 between the recirculation pump 18 and the location 45 at which the cleaning pump 38 is connected to the recirculation conduit upstream from the plurality of nozzle assemblies 32. The check valve 54 prevents back flow of washer fluid towards the recirculation pump 18, either when the recirculation pump is shut off and/or when the cleaning pump 38 is operating. Similarly, a check valve 56 is connected to the first supply conduit 43 between the cleaning pump 38 and the location 45 at which the cleaning pump and first supply conduit are connected to the recirculation conduit 26 upstream from the plurality of nozzle assemblies 32. This check valve 56 prevents back flow of washer fluid towards the cleaning pump 38 either when the cleaning pump is turned off and/or when the recirculation pump 18 is operating. Likewise, a check valve 58 is connected to the second supply conduit 47 between the cleaning pump 38 and the location 49 at which the cleaning pump is connected to the recirculation conduit 26 upstream from the nozzle assemblies 32 associated with the vehicle front windshield. This check valve 58 prevents back flow of washer fluid towards the cleaning pump 38 when the cleaning pump is turned off and/or when the recirculation pump 18 is operating. As can be seen from FIG. 2, the system 110 does not include this check valve. A check valve filter 60 may be associated with each of the check valves 54, 56, 58 to filter out any particles in the washer fluid so that these particles to not become stuck or otherwise disrupt the functioning of the system, especially in the cleaning performance of the nozzle assemblies.

Sensors may be included in the recirculation conduit 26, such as at a position that is just downstream from the recirculation pump 18 and upstream of the check valve 54. The sensors may include one or more of a flow sensor 62, a pressure sensor 64, and a temperature sensor 66. The flow sensor 62 measures the flow rate of the fluid in the recirculation conduit 26, the pressure sensor 64 measures the fluid pressure in the recirculation conduit, and the temperature sensor 66 measures the temperature of the fluid in the recirculation conduit. Measurement feedback from the sensors 62, 64, 66 may be used by a controller to adjust parameters of the system. For example, the system may optionally include a heater 68. The heater may be a heating element that is provided along the recirculation conduit either just upstream from the inlet 14 of the reservoir tank 12 or downstream from the outlet 16 of the tank and the recirculation pump 18. The heater 68 may heat the recirculation conduit which in turns heats the r fluid flowing through the recirculation conduit. The recirculating flow of the r fluid through the recirculation conduit and reservoir tank evenly disburses the heat throughout the fluid in the system. The controller uses feedback from the temperature sensor 66 to monitor the temperature of the fluid, and may turn the heater 68 on or off if the temperature is predetermined amount below or above a certain set point, respectively. Also, the controller may turn the pump on if the detected temperature is below a set point, so as to circulate and warm the washer fluid. Feedback from the flow sensor 62 and pressure sensor 64 may be used by the controller to monitor whether the recirculation pump 18 is functioning properly and/or if the pump is capable of variable output, to adjust the output of the pump.

As described above, the system may include a controller configured to operate the recirculation pump 18, the at least one cleaning pump 38, the recirculation control valve 52, and the valves 34 of the plurality of nozzle assemblies 32. The controller may operate the system in a variety of modes including but not limited to a recirculation mode, a front activation mode, a rear activation mode, and a component (sensor, camera lens, lamp, etc.) cleaning mode. The controller may include one or more of a circuit board, a CPU, a memory, a control algorithm, and other hardware or software.

In the recirculation mode, as shown in FIGS. 1, 2, and 4, the recirculation control valve 52 is at an open position to allow fluid flow through the valve so that washer fluid in the recirculation conduit 26 may pass through the valve and return to the reservoir tank 12. The recirculation pump 18 maintains an “on” state. Operation of the pump circulates washer fluid from the reservoir tank 12 (via the outlet 14) through the entire recirculation conduit 26 back to reservoir tank (via the inlet 16). Recirculation of the washer fluid resists or prevents the fluid from freezing in cold temperature conditions (e.g., below 0° C., below −5° C., below −10° C., or less). Also, as discussed above, if the system includes a heater 68, the activation of the heater in the recirculation mode to warm the washer fluid and further prevent freezing of the washer fluid. Either or both of fluid recirculation and heating of the washer fluid also allows for the use of lower strength or lower concentration antifreeze washer solutions, and/or washer solutions that do not include antifreeze, as well as alternative cleaning solutions. The recirculation mode is during non-use of the nozzle assemblies 32, i.e. when no fluid is ejected from the system, such that washer fluid is recirculated only during non-use of the nozzle assemblies.

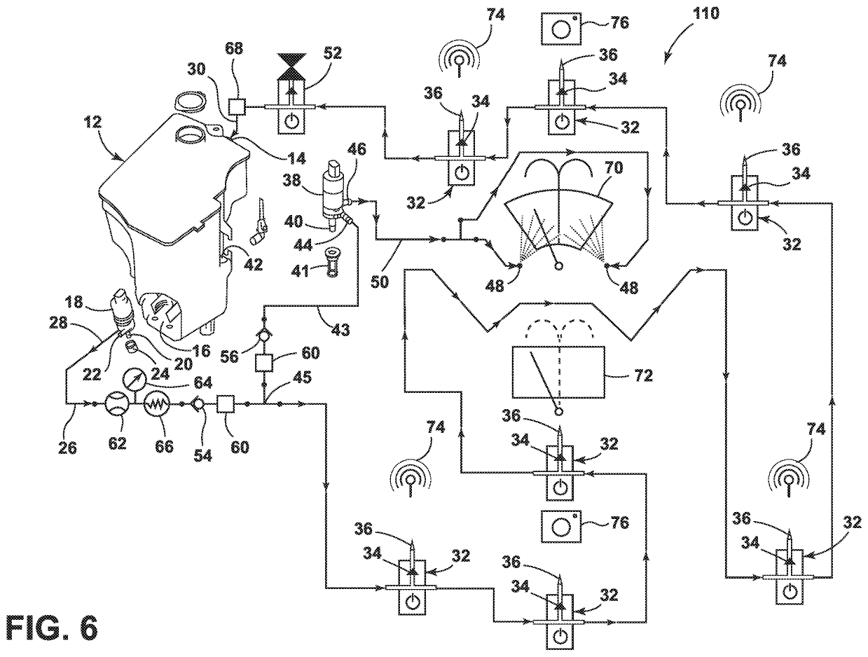

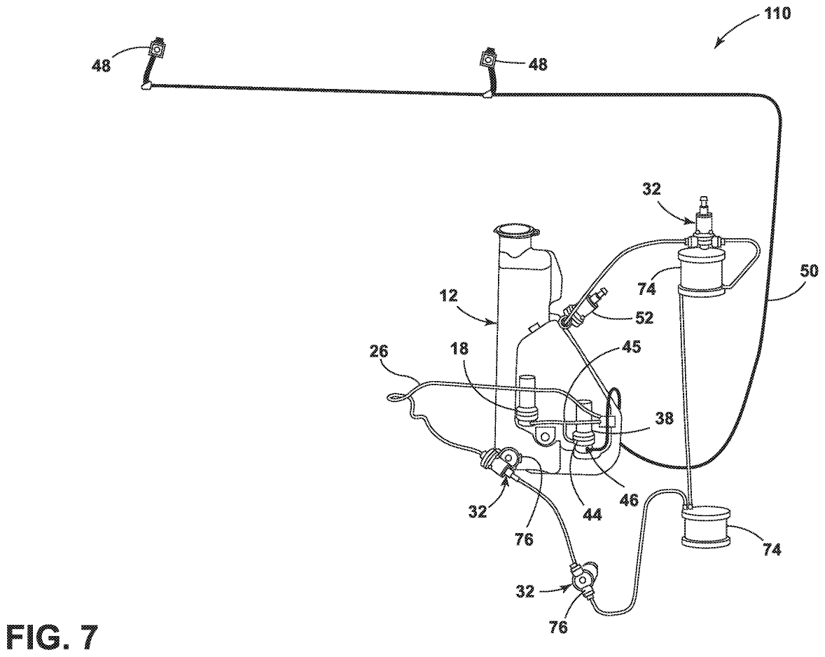

The front activation mode provides for the cleaning of the vehicle front windshield 70. The front windshield washing performed by the system may be arranged in one of two configurations as discussed above, either a traditional front washing arrangement or a recirculating front arrangement. In the traditional front washing arrangement shown in FIG. 6, the nozzles 48 for the front windshield are separate from the recirculation conduit 26 and are connected to the second outlet 46 of the cleaning pump 38 via the auxiliary conduit 50. Thus, in the front activation mode for the traditional front washing arrangement, the recirculation control valve 52 may remain open and the controller may maintain the operation of the recirculation pump 18 to continue to recirculate fluid in the recirculation conduit 26. In another alternative arrangement shown in FIG. 7, the recirculation control valve 52 may be closed and the controller may turn off operation of the recirculation pump 18 to cease recirculation of fluid in the recirculation conduit 26 during the front activation mode. To wash the front windshield, the controller actuates the cleaning pump 38 to deliver fluid out of the second outlet 46 into the auxiliary conduit 50. Actuation of the cleaning pump 38 causes washer fluid to be ejected from the windshield nozzles 48 (typically two, one for the driver side and one for the passenger side) onto the front windshield. It is noted that in the traditional front arrangement, the washer fluid in the auxiliary conduit 50 is not recirculated (as in traditional front windshield washing systems), and therefore in this arrangement the system does not have full washer fluid recirculation. Also, this arrangement is referred to as traditional as the windshield nozzles 48 are not electronically actuated nozzle assemblies but instead may be conventional windshield spray nozzles that are constantly in an open orientation (i.e., cannot be opened and closed). On the other hand, in the front activation mode for the recirculating front arrangement as shown in FIG. 5, the nozzle assemblies 32 for the front windshield are included in the recirculation conduit 26. Therefore, in this configuration, the recirculation control valve 52 moves to a closed position to prevent fluid in the recirculation conduit 26 from passing the valve and returning to the reservoir tank 12. Deactivation of the recirculation pump 18 so that washer fluid is temporarily not recirculated in the system. The controller then actuates the cleaning pump 38 to move fluid out of the second outlet 46 so that washer fluid is pumped from the reservoir tank and through the second supply conduit 47 to the location 49 in the recirculation conduit 26 that is just upstream from the nozzle assemblies 32 associated with the front windshield. Simultaneously, activation of the nozzle valves 34 of the nozzle assemblies associated with the front windshield to open these valves and allow fluid to be ejected from the spray nozzles 36 of these assemblies, thereby spraying washer fluid onto the front windshield. Two nozzle assemblies 32 may be associated with the front windshield, line for the driver side and one for the passenger side).

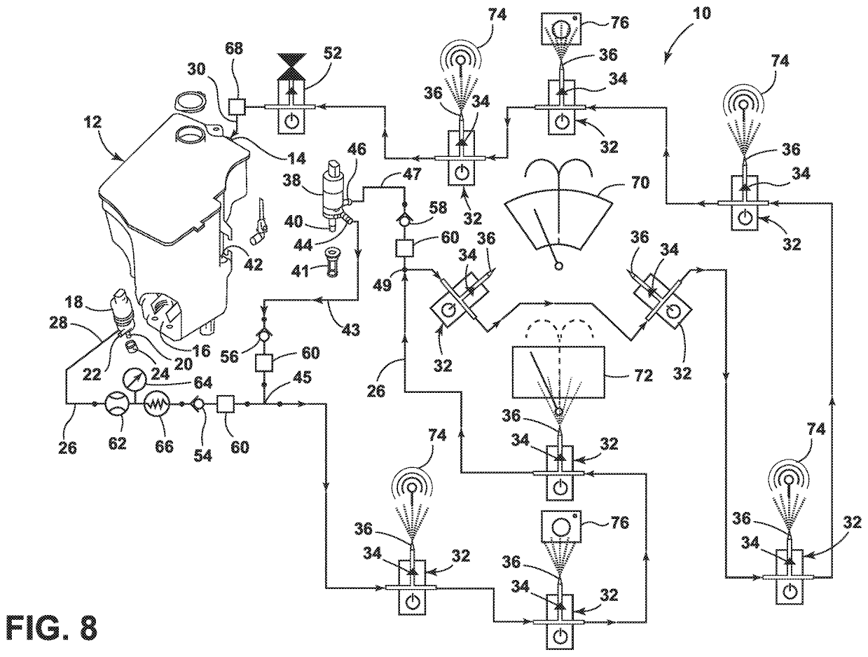

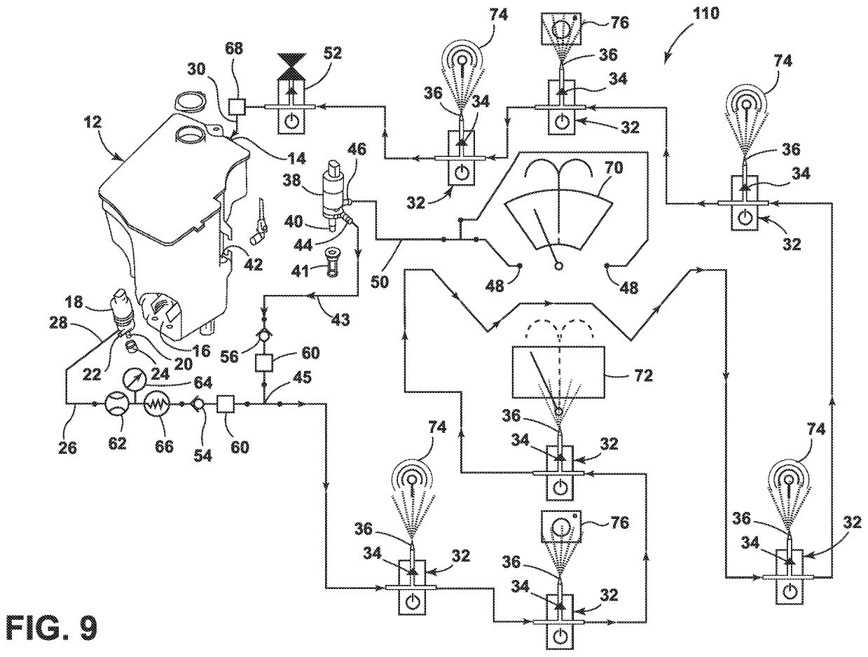

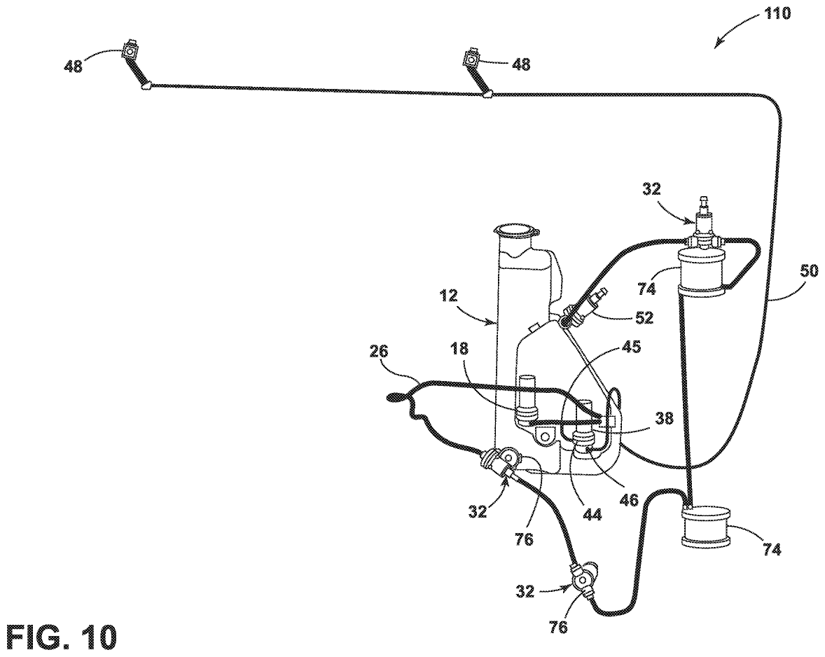

The rear activation mode provides for the cleaning of the vehicle rear window 72. In the rear activation mode, the recirculation control valve 52 moves to a closed position to prevent fluid in the recirculation conduit 26 from passing the valve and returning to the reservoir tank 12. The recirculation pump 18 is deactivated so that washer fluid is temporarily not recirculated in the system. Activation of the cleaning pump 38 to pump fluid out of the first outlet 44 so that washer fluid is delivered from the reservoir tank and through the first supply conduit 43 to the location 45 in the recirculation conduit 26 that is upstream from all of the plurality of nozzle assemblies 32 included in the system. Simultaneously, activation of the nozzle valve 34 of the nozzle assembly 32 associated with the rear window to open this valve and allow fluid to be ejected from the spray nozzle 36 of this assembly, thereby spraying washer fluid onto the rear window. Only one nozzle assembly may be associated with the rear window, although the system is not limited to such an arrangement and may include additional nozzles assembly(ies) associated with the rear window. Further, in a system having a traditional front arrangement, during the rear activation mode the cleaning pump 38 does not pump fluid out of the second outlet 46 into the auxiliary conduit 50 as shown in FIGS. 9 and 10. On the other hand, in a system having a recirculating front arrangement as shown in FIG. 8, the cleaning pump 38 may optionally also pump fluid out of the second outlet 46 through the second supply conduit 47 to the location 49. Operation of the pump 38 to move fluid from the second outlet 46 depends on whether fluid is to be ejected from other nozzle assemblies 32 downstream from the rear window nozzle assembly (i.e., if another mode is performed in tandem with the rear activation mode, as discussed in more detail below).

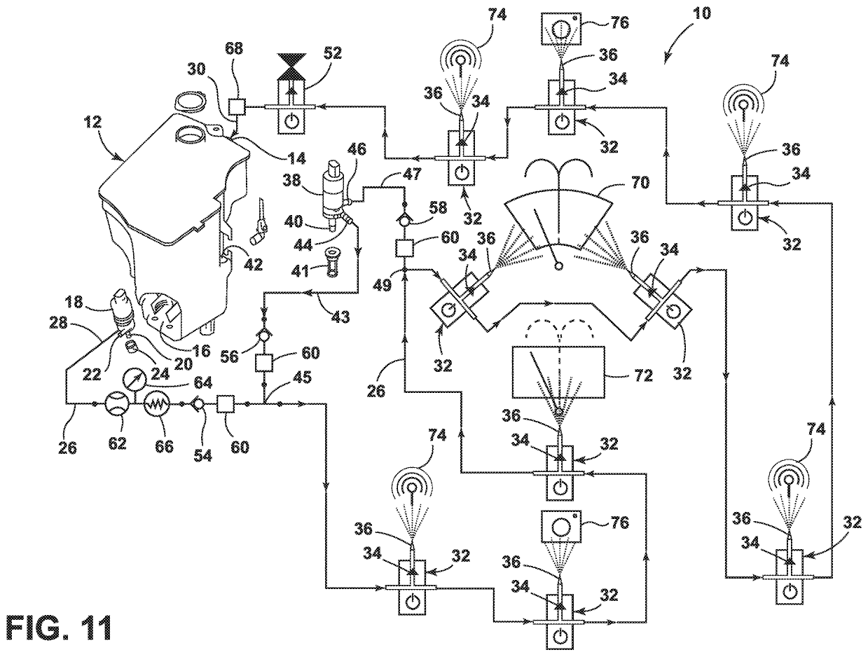

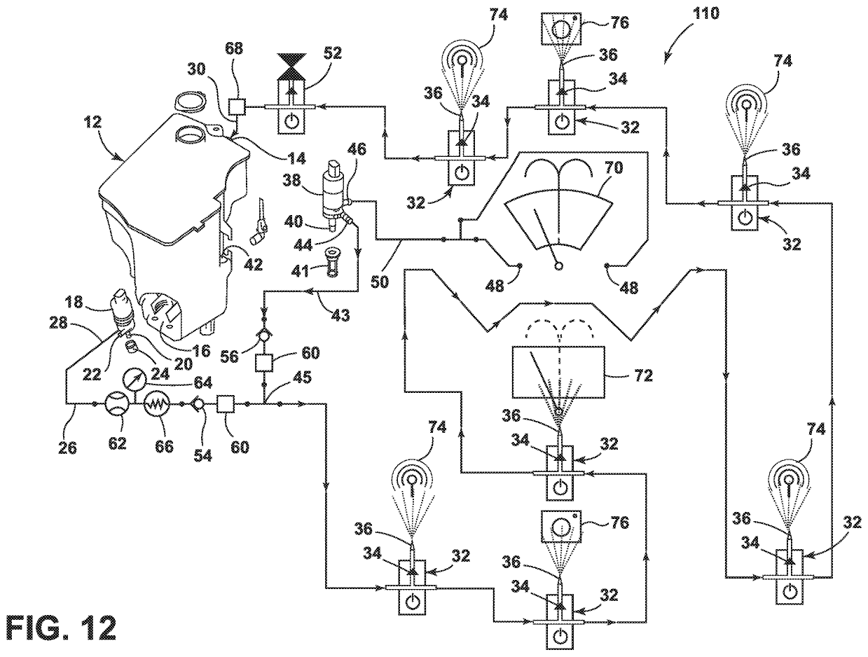

The component cleaning mode provides for the cleaning of external vehicle components including but not limited to sensors 74, camera lenses 76, head lamps (not shown), tail lamps (not shown), side markers (not shown), and the like. In the component cleaning mode, the recirculation control valve 52 moves to a closed position to prevent fluid in the recirculation conduit 26 from passing the valve and returning to the reservoir tank 12. The recirculation pump 18 is deactivated so that washer fluid is temporarily not recirculated in the system. Activation of the cleaning pump 38 to move fluid out of the first outlet 44 so that washer fluid is delivered from the reservoir tank and through the first supply conduit 43 to the location 45 in the recirculation conduit 26 that is upstream from all of the plurality of nozzle assemblies 32 included in the system. Simultaneously, activation of the nozzle valves 34 of one or more of the nozzle assemblies 32 associated with the stated vehicle components to open those valves, in order to spray washer fluid out of the nozzles 36 and onto those components. Further, in a system having a traditional front washing arrangement, during the component cleaning mode the cleaning pump 38 does not pump fluid out of the second outlet 46 into the auxiliary conduit 50 as shown in FIG. 12. On the other hand, in a system having a recirculating front arrangement as shown in FIG. 11, the cleaning pump 38 may optionally also pump fluid out of the second outlet 46 through the second supply conduit 47 to the location 49. Operation of the pump 38 to move fluid from the second outlet 46 depends in part on whether fluid is to be ejected from other nozzle assemblies 32 downstream from the rear window nozzle assembly as well as whether additional fluid pressure is to be provided downstream of the location 49 at which the second supply conduit 47 is connected to the recirculation conduit 26.

When the system is in the recirculation mode, no washer fluid is ejected from the nozzles of the system. On the other hand, when the recirculation mode is ceased in order to allow for spraying of washer fluid, the system may operate in any combination of the spray modes (front activation mode, rear activation mode, component cleaning mode). For example, the system may operate simultaneously in both the front activation mode and the rear activation to spray washer fluid on both the front windshield and the rear window. In another example, the system may operate simultaneously in both the rear activation mode and the component cleaning mode to spray washer fluid on both the rear window and the external vehicle components. In yet another example, the system may operate simultaneously in both the front activation mode and the component cleaning mode to spray washer fluid on both the front windshield and the external vehicle components. In yet another example, the system may operate simultaneously in the front activation mode, the rear activation mode, and the component cleaning mode. After the spray modes (front activation, rear activation, and component cleaning) are ceased, the system typically returns to the recirculation mode to resume circulation of the washer fluid through the system.

As apparent from the various operational modes of the system, during the spray modes a majority of the recirculation conduit 26 as well as one or both of the first and second supply conduits 43, 47 leading from the cleaning pump 38 and connected to the recirculation conduit (as well as the auxiliary conduit 50 of the traditional front arrangement, when present) together define a washer fluid supply path for the nozzle assemblies 32 and front windshield nozzles 48 (when present). Thus, a majority of the recirculation conduit 26 also functions as a supply line when the recirculation mode is ceased and one or more of the spray modes is activated. Also, it is apparent that the cleaning pump 38 is actuated only when fluid is ejected from the nozzle assemblies, and not during recirculation of washer fluid in the system.

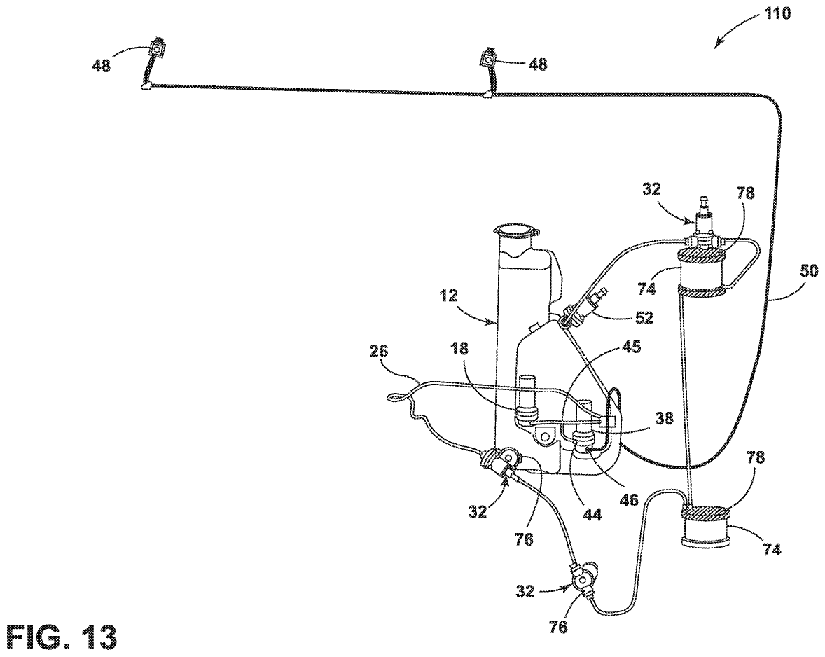

In yet other embodiments as shown by example in FIG. 13, the recirculation conduit 26 is routed through cooling plates 78 of the sensors 74 to transfer heat from the cooling plates to the fluid being recirculated through the recirculation conduit 26. This heat transfer removes heat from the sensors and adds it to the fluid in the recirculation conduit 26 to a source of heat while recirculating the fluid in the recirculation conduit. This configuration aids in heating the fluid to reduce freeze up as well as provides heated fluid cleaning to the surfaces being cleaned.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements by ordinal terms, for example “first,” “second,” and “third,” are used for clarity, and are not to be construed as limiting the order in which the claim elements appear. Any reference to claim elements in the singular, for example, using the articles “a,” “an,” “the” or “said,” is not to be construed as limiting the element to the singular.

1. A system for washing exterior surfaces of vehicle components, the system comprising:
a reservoir tank having a fluid recirculation inlet and a fluid recirculation outlet;
a recirculation pump in fluid communication with the fluid recirculation outlet of the reservoir tank;
a recirculation conduit having a first end in fluid communication with the recirculation pump and a second end in fluid communication with the fluid recirculation inlet of the reservoir tank;
the recirculation pump and the recirculation conduit forming a closed loop between the reservoir tank outlet and reservoir tank inlet, the recirculation pump configured to be actuated to circulate fluid to and from the reservoir tank through the recirculation conduit;
a plurality of nozzle assemblies connected to the recirculation conduit at various positions along the recirculation conduit, the nozzle assemblies each including a nozzle valve and spray nozzle, the nozzle valve configured to be actuated to communicate fluid from the recirculation conduit to the spray nozzle;
a recirculation control valve in fluid communication with the recirculation conduit, the recirculation control valve being connected to the recirculation conduit at a location downstream from the plurality of nozzle assemblies and upstream from the reservoir tank inlet;
at least one cleaning pump in fluid communication with the reservoir tank and the recirculation conduit, the at least one cleaning pump being connected to the recirculation conduit at a location upstream from the plurality of nozzle assemblies, and the at least one cleaning pump being configured to be actuated to eject fluid from the nozzle assemblies;
wherein the recirculation pump is actuated only for recirculation of fluid through the recirculation conduit, and the cleaning pump is actuated only to eject fluid from the nozzle assemblies.

2. The system of claim 1, wherein the at least one cleaning pump is additionally connected to the recirculation conduit at a location upstream from nozzle assemblies associated with a vehicle front windshield.

3. The system of claim 2, including only one cleaning pump, wherein the only one cleaning pump has a first outlet connected to the location upstream of the plurality of nozzle assemblies, and a second outlet connected to the location upstream of the nozzle assemblies associated with the vehicle front windshield.

4. The system of claim 1, including an auxiliary conduit in fluid communication with the at least one cleaning pump and a plurality of nozzles associated with a vehicle front windshield.

5. The system of claim 1, including a check valve connected to the recirculation conduit between the recirculation pump and the location at which the at least one cleaning pump is connected to the recirculation conduit upstream from the plurality of nozzle assemblies.

6. The system of claim 1, including a check valve connected between the at least one cleaning pump and the location at which the at least one cleaning pump is connected to the recirculation conduit upstream from the plurality of nozzle assemblies.

7. The system of claim 2, including a check valve connected between the at least one cleaning pump and the location at which the at least one cleaning pump is connected to the recirculation conduit upstream from the nozzle assemblies associated with the vehicle front windshield.

8. The system of claim 1, wherein the plurality of nozzle assemblies are associated with one or more of external sensors, external camera lenses, headlamps, tail lamps, side markers, turn signals, a front windshield, and a rear window.

9. The system of claim 1, wherein the recirculation control valve and the valve of each valve assembly are electronically controlled valves.

10. A method of washing exterior surfaces of external vehicle components, the method comprising the steps of:
providing the system of claim 1;
opening the recirculation control valve and actuating the recirculation pump to circulate washer fluid to and from the reservoir tank through the recirculation conduit during non-use of the nozzle assemblies;
during use of the nozzle assemblies, deactivating the recirculation pump, closing the recirculation control valve, actuating the at least one cleaning pump, and opening one or more of the nozzle valves of the plurality of nozzle assemblies to eject washer fluid from the associated spray nozzles;
wherein washer fluid is recirculated only during non-use of the nozzle assemblies.

11. The method of claim 10, wherein the at least one cleaning pump is actuated to deliver washer fluid from the reservoir tank to the location upstream of the plurality of nozzle assemblies.

12. The method of claim 10, wherein the at least one cleaning pump is actuated to deliver washer fluid from the reservoir tank to a location upstream of nozzle assemblies associated with a vehicle front windshield.

13. The method of claim 10, including the step of measuring the temperature of the washer fluid in the recirculation conduit.

14. The method of claim 13, including the step of controlling the recirculation pump based on the measured temperature.

15. The method of claim 13, including the step of controlling the temperature of the washer fluid based on the measured temperature.

16. The method of claim 10, including the step of transferring heat from one or more of the vehicle components to the washer fluid in the recirculation conduit.
